(19) United States
(12) Patent Application Publication
(10) Pub. No.: US 2020/0074552 A1
(43) Pub. Date: Mar. 5, 2020

(54) SYSTEMS AND METHODS FOR SHORT AND LONG TOKENS

(71) Applicant: NOVERA CAPITAL INC., Toronto (CA)

(72) Inventors: Charles Louis Shier, Toronto (CA); Marek Laskowski, Toronto (CA); Jacob Issac Unger, Toronto (CA); Henry Michael Kim, Toronto (CA)

(21) Appl. No.: 16/553,709

(22) Filed: Aug. 28, 2019

Related U.S. Application Data
(60) Provisional application No. 62/723,990, filed on Aug. 28, 2018.

(51) Int. Cl. G06Q 40/06; G06Q 20/38; G06Q 40/04

(52) U.S. Cl. CPC G06Q 40/06; G06Q 20/381; G06Q 20/389; G06Q 2220/00; G06Q 40/04

(57) ABSTRACT

A long and short fund that is implemented using a distributed token-based system. A change in an indicator causes assets to be moved from one fund to the other. Investors may redeem their fund units at any time, including at the conclusion of the fund when one of the funds reaches zero value. A cryptographic whitelist may be used to ensure that only validated investors hold or redeem units of the funds. Offering memorandum and auditing documentation may be cryptographically attached to the token.

### CROSS-REFERENCE TO RELATED APPLICATIONS

This application claims priority under 35 U.S.C. § 119(e) to U.S. Provisional Patent Application Ser. No. 62/723,990, titled “SYSTEMS AND METHODS FOR SHORT AND LONG TOKENS,” filed Aug. 28, 2018, which is incorporated herein in its entirety for all purposes.

### TECHNICAL FIELD

The present disclosure relates to a secure allocation of assets based on an external indicator. In particular, it relates to a distributed ledger enabled allocation tracking of an indicator.

### BACKGROUND

Funds to track an index have existed in several markets implemented using an allocation of fiat money. Depending on the movement of an index, investors in the funds may achieve a greater or lesser degree of return.

In such a scenario, an inventor is dependent on the manager of the fund to maintain any invested money during the life of the fund as well as have sufficient capital to pay out to the investor either at the time of the conclusion of the fund or at an earlier point of redemption.

Investors have to trust the manager in such a scenario to accurately track the index the investor and the manager had agreed on as well as take appropriate actions in a timely manner such as in response to conclusion of the fund or requests for redemption.

It is therefore desirable to have a distributed system for maintaining and allocated assets based on an external index.

### SUMMARY

In accordance with an aspect disclosed herein, there is provided a method for facilitating investments. The method comprises issuing ownership units in a long fund to investors, the ownership units in the long fund having values that increase based on an upward movement of an external indicator and that decrease based on a downward movement of the external indicator, issuing ownership units in a short fund to investors, the ownership units in the short fund having values that decrease based on the upward movement of the external indicator and that increase in value based on the downward movement of the external indicator. Each ownership unit in the long fund is issued for each ownership unit in the short fund issued. The ownership units in the long fund increase in value to by a same amount by which the ownership units in the short fund decrease in value for a given change in the external indicator. The method further includes maintaining ownership and transactions records associated with the ownership units in the long and short funds in cryptographically secure tokens on a blockchain.

In some embodiments, the ownership units in the long and short funds may be traded only prior to the net asset value of one of the long fund or the short fund dropping to zero.

In some embodiments, the method further comprises freezing trading of ownership units in the long and short funds responsive to the net asset value of one of the long fund or the short fund dropping to zero, canceling all previously issued ownership units in the one of the long and short funds with the net asset value that dropped to zero, issuing new ownership units in the one of the long and short funds with the net asset value that dropped to zero, and resuming trading responsive to a number of newly issued ownership units in the in the one of the long and short funds with the net asset value that dropped to zero matching the number of outstanding ownership units in the other of the long and short funds.

In some embodiments, the method further comprises forcing redemption of all ownership units in the one of the long and the short fund other than the one of the long and short funds with the net asset value that dropped to zero.

In some embodiments, trading of the ownership units in the long and short funds is implemented by one or more smart contracts recorded on the blockchain.

In some embodiments, the method further comprises checking a whitelist responsive to a request by an investor to purchase, trade, or redeem ownership units in the long and short funds, and only permitting the investor to purchase, trade, or redeem the ownership units if the investor is included in the whitelist.

In some embodiments, the whitelist is recorded on the blockchain and is updateable by an administrator of the long and short funds.

In some embodiments, the external indicator is an exchange rate for a unit of a cryptocurrency.

In some embodiments, each of the ownership units in the long and short funds are assigned a same strike value of the external indicator against which changes in the external indicator are evaluated to determine value of the ownership units in the long and short funds.

In some embodiments, each of the ownership units in the long and short funds are issued at a same price.

In some embodiments, a maximum appreciation or depreciation in value of each of the ownership units in the long and short funds is capped at 100%.

In some embodiments, a percentage change in a value of the external indicator causes value of the ownership units in the long fund to change by the same percentage as the percentage change in the value of the external indicator and value of the ownership units in the short fund to change by a negative of the percentage change in the value of the external indicator.

In some embodiments, the ownership units in the long and short funds have values that are leveraged relative to changes in value of the external indicator wherein a percentage change in the value of the external indicator causes the value of the ownership units in the long fund to change by a non-unit multiple of the percentage change in the value of the external indicator and value of the ownership units in the short fund to change by a negative of the non-unit multiple of the percentage change in the value of the external indicator.

In some embodiments, redemption of ownership units in one of the long and the short fund comprises exchanging one ownership unit of the long fund and one unit of the short fund for one unit of a stable value stablecoin, exchanging one stablecoin for one issuer credit, and exchanging the issuer credit for fiat currency.

In some embodiments, issuing the ownership units in the long and the short fund comprises exchanging fiat currency for a stable value stablecoin, and exchanging the stablecoin for one ownership unit in the long fund and one ownership unit in the short fund.

In some embodiments, the ownership units in the long and short funds are initially issued in equal amounts and at equal prices and wherein net asset values of the long and short funds are equal after initial issuance of the ownership units.

In some embodiments, trading in the ownership units in the long and short funds does not begin until after the initial issuance is completed.

In some embodiments, the method further comprises entering prospective inventors on a waitlist for ownership units of a one of the long fund or the short fund that are more in demand until issuance of sufficient ownership units in the other of the long fund or the short fund to make a number of ownership units issued in each of the long fund and short fund equal.

In some embodiments, the method further comprises recording a strike value of the ownership units in the long and short funds in the tokens on the blockchain.

In some embodiments, the method further comprises cryptographically tying auditing records of the long and short funds to the tokens on the blockchain. In some embodiments, the method further comprises obtaining quotes of a value of the external indicator at set times from multiple sources and aggregating consensus regarding the value of the external indicator at each of the set times through a smart contract implemented on the blockchain.

In some embodiments, the method further comprises cryptographically tying one or offering memorandum for the ownership units in the long and short funds to the tokens on the blockchain.

### BRIEF DESCRIPTION OF THE DRAWINGS

In drawings which illustrate by way of example only embodiments of the present disclosure, in which like reference numerals describe similar items throughout the various figures,

FIG. 1 is a schematic diagram of entities involved in an allocation of funds.

FIG. 2 is a schematic diagram of a token.

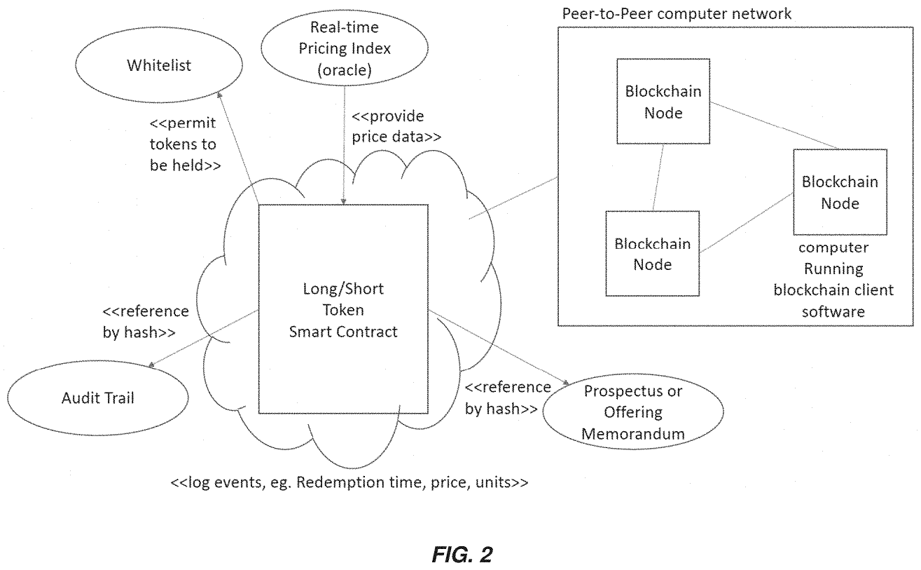

FIG. 3 is a schematic diagram of relationships involved in an offering memorandum transaction.

FIG. 4 is a schematic diagram of relationships involved in a whitelist transaction.

FIG. 5 is a schematic diagram of relationships involved in an audit transaction.

FIG. 6A is a schematic diagram of determining an indicator value in a decentralized embodiment.

FIG. 6B is a schematic diagram of determining an indicator value in a centralized embodiment.

FIG. 7A is a schematic diagram of a redemption and payment transaction.

FIG. 7B is a schematic diagram of a redemption using both a long and short token.

FIG. 8A illustrates an example of the change in value of long and short fund units over time.

FIG. 8B illustrates an example of recapitalization of a side of a paired long/short fund that has a value that has dropped to zero.

FIG. 9 illustrates advantages of embodiments of the system and method disclosed herein.

### DETAILED DESCRIPTION

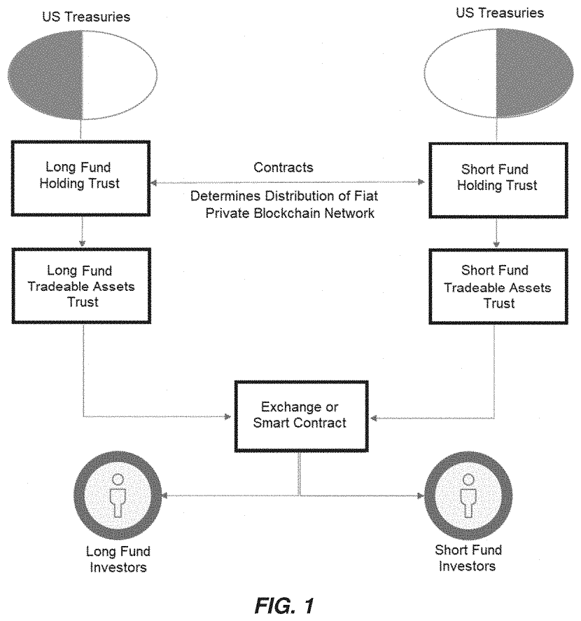

With reference to FIG. 1A, two related funds, a first fund and a second fund, have an asset allocation, such as the net asset value (NAV), divided between them determined based on an external indicator. The indicator may be an index, such as a real-time or periodically updated index. An example of an index is the exchange rate of a currency, such as USD/Euro or Bitcoin. The index may be an index from a financial market, for example, the Dow Jones Industrial Average. The indicator may be unrelated to the financial markets, for example, the temperature at Toronto's Pearson Airport as reported by Environment Canada. The indicator is a number representing something external to the funds that can increase or decrease based on an externality.

The asset allocation may be an inverse capital allocation relationship (short & long) tracking the indicator. When the indicator increases, assets may be moved from the first fund to the second fund. Similarly, when the indicator decreases, assets may be moved from the second fund to the first fund. The amount of assets that are moved may depend on the amount the indicator changes. The assets may be physically moved between the two funds or the total assets may be kept in a constant location while a record of how much of the total assets are associated with each fund is modified.

Units, represented by and also referred to herein as shares or tokens, may be sold to investors (also referred to herein as subscribers or users) in the funds. The units are sold at a ratio of 1:1 so that one unit of the first fund is sold for each unit of the second fund that is sold. If demand is greater for units of one fund than the other, a waitlist may be maintained for prospective investors of the fund that is more in demand. An investor may hope to obtain more than their original investment if the indicator moves in a favorable direction. For example, an investor in the ‘long’ fund may benefit if the indicator moves up, such that the value of the assets of the long fund may become larger. Therefore, the units for the fund will increase in value. Conversely, an investor in the corresponding ‘short’ fund may lose some or all of their investment if the indicator moves up and assets of the short fund are moved to the long fund.

Over time, as the indicator may change, and the value of the assets of a fund are changed. The value of the assets in the funds may change by the same percentage as a change in the indicator. For example, if the indicator increases by 25%, the value of the assets in the long fund (and the value of a unit of the long fund) may increase by 25% and the value of the assets in the short fund (and the value of a unit of the short fund) may decrease by 25%. If the indicator decreases by 25%, the value of the assets in the long fund (and the value of a unit of the long fund) may decrease by 25% and the value of the assets in the short fund (and the value of a unit of the short fund) may increase by 25%. In other embodiments, the value of the assets in the funds, and the value of the respective units, may be leveraged as discussed in further detail below, such that the values of the assets and units change as a multiple of a change in value of the indicator.

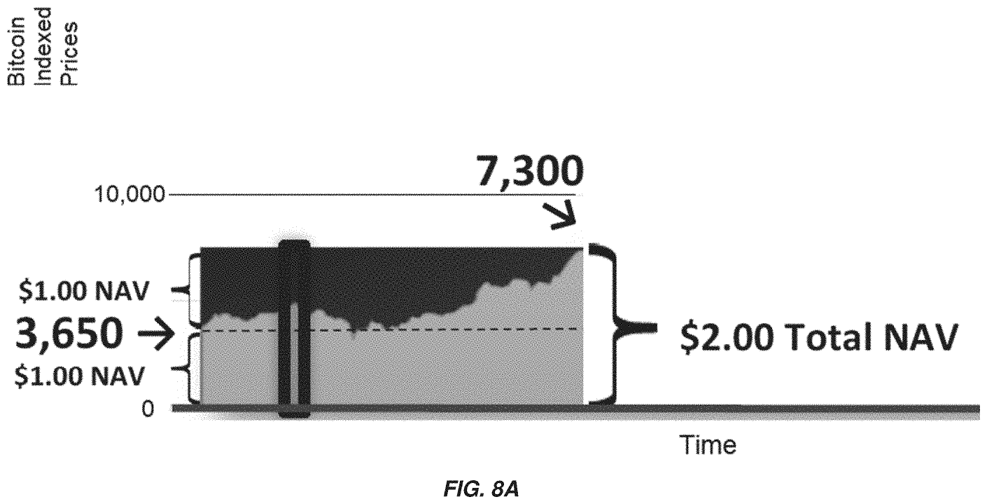

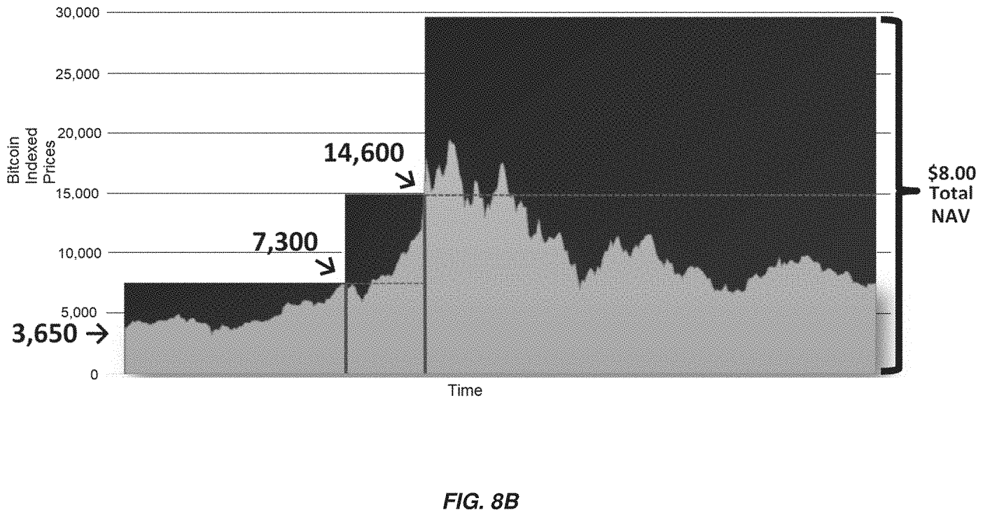

If the value of one fund reaches zero (corresponding to a 100% increase in the other fund) trading of the units is automatically halted. The value contained in the fund that increased 100% are either redeemed or rolled over into a new re-capitalized vehicle. For example, with reference to FIG. 8A, a long fund and a corresponding short fund with values that change with changes in the price of Bitcoin are initially capitalized with a value of one dollar each with a strike price of the units of each fund set at the price of Bitcoin at the time of capitalization of the fund, $3,650. Over time, the price of Bitcoin doubles to $7300. At this point the price of the units of the long fund have doubled and the price of the units of the short fund have dropped to zero. The NAV of the long fund has increased from one dollar to two dollars and the NAV of the short fund have dropped from one dollar to zero. Trading of units in the fund may be halted when the price of Bitcoin reaches $7300. At this point, investors who hold units of the long fund may redeem their fund units and the fund closes. Alternatively, as illustrated in FIG. 8B additional units of the short fund may be issued until the number of short fund units matches the number of long fund units again and trading resumes with the new initial NAV of each of the long and short fund being two dollars each. This process may be repeated if the price of Bitcoin again doubles from $7,300 to $14,600 with the new initial NAV of each of the long and short fund being four dollars each for a total investment fund NAV of eight dollars.

Funds may be recapitalized at a 1:1 ratio as between the long and short funds. Funds provided by investors for the purchase of units of the funds may be placed into one or more accounts, such as trust accounts, or high interest-bearing bank accounts, between which value is allocated. The funds may be held in trust, escrow, or with a custodian bank.

Each fund may maintain the assets in a suitable manner, such as in a bank account, high interest-bearing account, or U.S. Treasuries if the assets are fiat currency, such as U.S. dollars. The assets may be maintained as tokens on a blockchain associated with a key related to each of the first and second funds if the assets are a cryptocurrency.

Units in the first and second funds may be traded. Investors may trade the units based on their expectation of the future value of the funds as dictated by the change in the indicator. Units in the funds could be comprised of exchange traded products (ETPs) or cryptographic tokens traded on a blockchain.

Additional units may be issued after the initial capitalization. Additional units may be issued that have the same strike value as the original distributed units, or the additional units may have a different strike value, perhaps because the indicator value has changed since the original distribution, or because of different investor demand or sentiment. Units issued with a different strike value may be considered as part of a separate offering, with a different OM/prospectus. Additional units may be issued periodically, such as daily, weekly, monthly, quarterly, yearly, or some other period. The units may be issued on demand, such as because of interest from subscribers/investors. The units may be issued in the form of a long unit and short unit issued simultaneously or as a “stablecoin,” combining the two units. The stablecoin may be split into a long unit and a short unit at a later date. The strike price may be included in the stablecoin, such that the long unit and short unit that result have the strike price at the time the stablecoin was issued. The long and short units of a stablecoin may not be issued until after a hold period has passed, such as for allowing any regulatory or escrow approvals.

Each of funds may include long units, short units, and stablecoins. The sum of the valuation of the long units, short units, and stablecoins of a fund may add up to the NAV of the fund. The funds may additionally include another unit of account that is independent of all other assets in the fund ecosystem, the Issuer Credit. The long units, short units, and stablecoins of a fund may be embodied as an ERC-20 Ethereum Token Smart Contract, or a similar token on a different blockchain, either public or private, while the Issuer credit is not. An Issuer credit may ne non-transferable between subscribers/investors. The purpose of the Issuer credit is to provide a means for users take money/value out of one fund and put it into another. The Issuer credit provides a means for users to do a “soft redemption,” which means they're out of investing into a specific fund but are still in the fund ecosystem and can get reinvest their assets in one of the funds at a later time. The Issuer credit also helps streamline the business process for managers of the funds when it comes to helping users completely redeem from the investment fund ecosystem back into fiat currency.

As described below, cryptographic tokens may be used to maintain the units in the funds, allow a secondary market in the units and allow for redemption of the units. The tokens may securely track the indicator to allow redemptions as well as provide assurances as to investors whom are qualified to make transactions with respect to the units of the funds. The tokens may also provide assurances to users and the process of managing the investment funds has been audited.

Cryptographic tokens may be implemented as an ERC-20 Ethereum Token Smart Contract, or a similar token on a different blockchain, either public or private.

Blockchain refers to distributed ledger technologies (DLTs) that includes a network of computers, each referred to as a node. The network is, in some implementations, not under control of a single party. A peer-to-peer protocol may be used to maintain consensus between the nodes of the network of computers as to information tracked on the blockchain, for example, values of the long and short units of the investment funds and records of transactions regarding same. The blockchain may employ a virtual machine that implements a language whereby executing statements of the language relating to a token may affect the internal state of the machines, such as memory, relating to the token. The Ethereum network is one example of a blockchain.

The tokens could be implemented as multiple contracts with distinct addresses or a single contract. A contract or smart contract refers to the code written in the language executed by the virtual machine on the blockchain.

If an equal amount of investment was obtained or was collected on each side, for each fund, short and long, the initial allocation is 50/50. At the time that the NAV allocation begins, the value of the indicator being tracked is recorded and called the strike value. This value can be recorded in the tokens to ensure cryptographic security of these values. The initial NAV of the fund is also recorded as the current NAV of the fund.

Thereafter, the NAV allocation between short and long positions may be calculated as follows:

Net Asset Value is computed as NAV=money raised−expenses (1)

The indicator value change may be determined, expressed as a fraction as follows:

indicator_change=(Current_indicator_value−strike_value)/strike value (2)

The allocation of the assets to the long side (NAV of Long) fund may be computed as:

long_allocation=NAV*(1+indicator_change)/2 (3)

The allocation of the assets to the short side (NAV of Short) fund may be computed as:

short_allocation=NAV−long_allocation (4)

Leveraged products may be provided, by adding a leveraged multiplier (LEV) to the price change calculation. For example, the indicator value change may be calculated as:

indicator_change=LEV×(Current_indicator_value−strike_value)/strike_value (5)

For example, if the LEV was 2.0, a 50% movement in the external indicator value may result in a 100% movement in the price.

Other relationships between indicator value and change may be used. For example, a formula may be used to provide a change in fund (or fund unit) value based on a change in an indicator value within a range. For example, the indicator_change may be calculated as:

Indicator_change=LEV×(Current_indicator_value−strike_value)/(indicator_value_spread) (6)

In an example, if the temperature is used as an indicator value, the strike value may be 15 degrees Celsius, with an indicator value spread of 10 degrees Celsius. Therefore, if the temperature is 20 degrees and the LEV is 1, the indicator_change is 50%. In this example, the value of the short fund and its respective units would drop to zero if the temperature rises to 25 degrees and the value of the long fund and its respective units would drop to zero if the temperature drops to 5 degrees.

### Indicator

Determining the current value of the indicator may be implemented by an “Oracle” associated with the indicator. The current value of the indicator may be determined in real-time, near real-time, or periodically.

The rate of updates to the token(s) may can be adaptive to conditions pertaining to the indicator. For example, more frequent updates may be performed if the indicator is more volatile. A target update period of 1 update per minute may represent a choice for minimum rate for updates on the blockchain. Alternatively or in addition, updates may be performed for the token if a threshold is reached, such as 1% change in value of the indicator or of the units of a fund.

The terms “token” and “smart contract” as used herein are to be understood as referring collectively to each of the tokens and smart contracts associated with units of the long and short investment funds in embodiments in which multiple tokens or smart contracts are utilized.

Indicator providers, including real-time value-tracking data, are selected, such as being predetermined or determined based on an algorithm or some set of criteria. The resulting set of indicator value sources may be used to determine the “spot price” of said tracked value. The source of the indicator may be referred to as an “Oracle.”

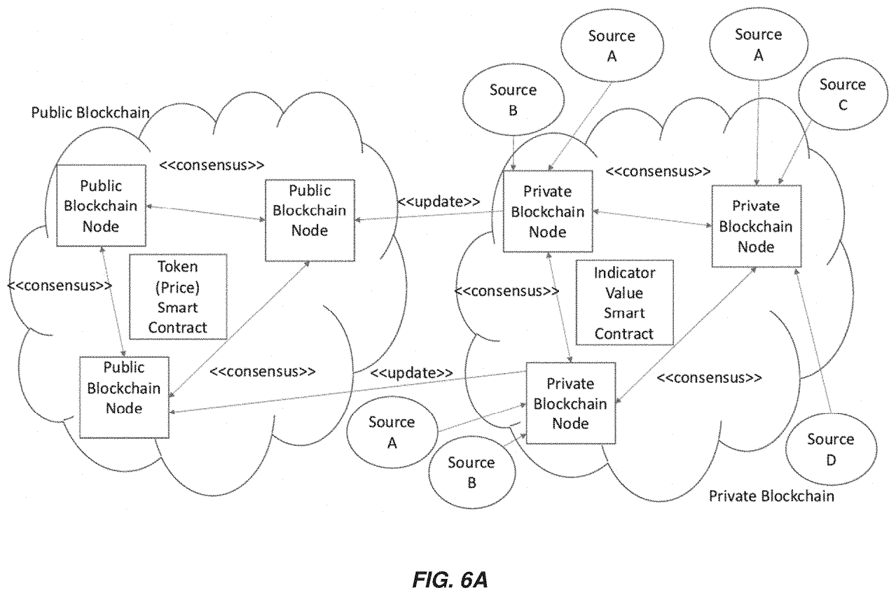

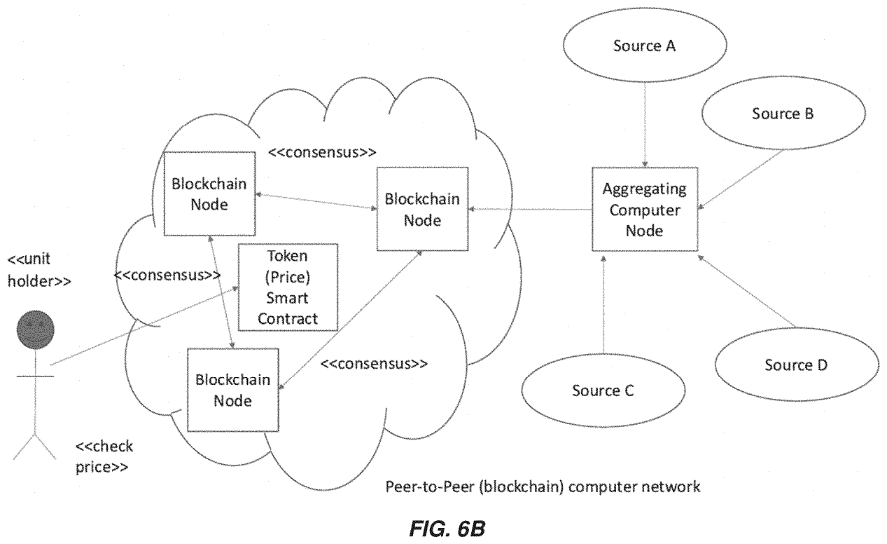

With reference to FIG. 6A, for a decentralized indicator source, such an indicator source for the current exchange rate for Bitcoin, a consensus process may be used. Consensus on the indicator value, such as the Bitcoin exchange rate, across many geographical locations could be accomplished using a distributed architecture, which could be embodied as a blockchain network. Aggregation of consensus may be implemented through a smart contract implemented on the blockchain. Alternatively, this could be achieved with a more traditional distributed systems approach not using a blockchain. Indicator value may be aggregated in time intervals, for example, over one second. Price source selection could be reorganized by “style” or “approach,” e.g., public vs. private blockchain.

With reference to FIG. 6B, for a centralized point of indicator value aggregation, a single computer node may collect real-time data (e.g., price of Bitcoin) from a set of included sources (Sources A-D in FIG. 6B). It may apply an averaging algorithm, for example, volume weighted averaging. Optionally, the single computer node may use only the latest data from each source. Optionally, the top and bottom quotes may be dropped from the averaging calculation to reduce the risk of an outliner value from one of the sources, for example, due to illiquidity on one exchange, from significantly affecting the calculated indicator value. This single computer node is effectively an oracle that provides or writes the updated indicator value to the token.

With reference to FIG. 6A, for a decentralized indicator value determination, a private blockchain network may be used with each node receiving indicator values from one or more sources and writing them to a smart contract. A private blockchain may be used to achieve consensus about the times at which the indicator value is checked and/or updated. The smart contract may reside on the blockchain where multiple indicator value signals may be received and the smart contract algorithms apply decision rules on-chain as to how to update the indicator value.

Two or more blockchain nodes may be in consensus about the time. Such implementation may be done using blockchain technology, such as Intel Sawtooth blockchain.

During one value determination time interval, a set of nodes receives an indicator value signal (e.g., price) from a source or set of sources. For example, in an embodiment where the exchange rate of Bitcoin is the indicator, a source may be a cryptocurrency exchange that passes certain criteria for inclusion. For example, the criteria may be inclusion on a pre-determined list, a sufficiently long reporting history, or a sufficient trading volume.

Optionally, the nodes are assigned sources in such a way that more than one node receives and can verify data coming from any one source. Nodes running the software collect information on an indicator, such as exchange rate quotes, during a particular time determination interval T1 (as defined by the time consensus between the nodes) and then use a second, consensus period, T2, to establish an aggregate observation for the indicator being tracked. The nodes may collect information on an indicator using an API, such as a REST API, from a data source server.

Nodes may then broadcast their indicator value observations to the other nodes and accordingly, nodes receive indicator value observations from other nodes. The sending and receiving is done using protocols on the blockchain.

Each node in said set of nodes establishes an indicator level for each source in the set of sources by each performing determinations, such as described above in the centralized version, to establish the consensus indicator value.

The indicator value may be recorded in the token(s) associated with the investment funds. The computation of the aggregate indicator value may be accomplished in a transparent manner on a public blockchain using the token contract(s), or a second contract which is directed to computing and maintaining a price index.

If a private blockchain is used, such as described above, each of the nodes may run two instances of blockchain client software connecting the node to both the private and the public blockchains. Each of the nodes may have a distinct cryptographic address that identifies the node to the primary token contracts on the main public blockchain.

During each said T2 consensus period, each node sends its evidence to the token or indicator value smart contract, if used.

The token contract performs an indicator value consensus rule price determination function using input from each of the nodes as evidence. Alternatively, the aggregate price can be similarly computed on the private blockchain, either off-chain by the nodes, or using a smart contract on the private blockchain.

Alternatively, the aggregating computer nodes could rely on a trusted third party (e.g., NTP) to synchronize on T1 and T2, foregoing a blockchain solution, and use one of the smart contracts residing on a public blockchain implementing the price consensus rule.

Several means of achieving consensus and byzantine fault tolerance (BFT) between the nodes exist, such as proof of work, (delegated) proof of stake, proof of authority, and other BFT protocols. In the case of some BFT protocols each node may validate and verify the calculation of the indicator by performing the same calculation on available data, and if valid, the node will sign a block of the blockchain including information regarding the value of the indicator with its private key.

In protocols with a designated leader node, for example, Proof of Work, only the leader node will sign the block and other nodes will propagate it if valid (per the above).

In a proof-of-authority system n out of m nodes may need to sign the candidate block, finalizing it.

During the T2 consensus interval if indicator value data from a single node deviates from indicator values submitted by other nodes, or if the single node propagates invalid blocks, the single node can be put in a special list by each other node, and indicator value information from the single node may be ignored in future calculations.

This process adds to the security of the system as a majority (at least 51%) of nodes would have to be individually compromised to affect the tracked value (Byzantine Fault Tolerance).

In addition to a blockchain solution as described above, a centralized version may exist as a backup in case of network failure, consisting of an ordinary web server publishing updates for the indicator value, for example, using RSS. The web server where the indicator value is hosted could receive signed indicator messages by multiple internet nodes (i.e., computers). If submitted indicator values do not agree, action can be taken as severe as terminating the nodes and re-instantiating all nodes.

To guard against price manipulation the highest and lowest indicator value quotes may be dropped from the indicator value calculation, and the remaining indicator value quotes averaged, weighted-averaged, or a similar scheme.

The latest indicator value is written to the smart contract or token(s) associated with units in the investment funds. If this new indicator value causes one of the funds to be valued at 0 then trading may be stopped and redemptions permitted. Alternatively, tokens may be reissued in a new fund.

Any interested parties may observe the blockchain and receive updates to the indicator value by having an up-to-date copy of the blockchain.

### Updating Indicator Value

Updating indicator value in the smart contract of the token may be done using the following steps in a decentralized system:
A. An oracle computer node receives pricing information from multiple sources regarding the indicator value. This may be obtained from an online source, such as using an API, such as a REST API, from a data source server.
B. The oracle computer node may obtain information regarding the value of the indicator from a single, or optionally, multiple pricing sources. If utilizing multiple pricing sources, the oracle may perform an aggregating operation on the indicator value information and determine an aggregate indicator value that is representative of said indicator value being tracked. For example, a volume weighted moving average may be determined from the multiple sources.
C. The oracle computer node may perform a comparison of the time elapsed since the indicator value was last updated on the smart contract. If this time period exceeds a threshold, an update transaction may be performed, as described below. Additionally or alternatively, the node may compute the difference in the indicator value since the last update. If the magnitude of the indicator value difference exceeds a threshold, an update transaction may be performed. If the change in indicator value causes one of the fund NAV allocations to fall to zero, an update transaction may be performed. Additionally, an update transaction may be triggered at a predetermined time of day, for example, for end-of-day or closing of some other period's price.
D. The oracle computer node creates a transaction which will be used to update the indicator value stored on the smart contract. This transaction includes the new indicator value to be stored in the smart contract.
E. The oracle computer node signs the update transaction with the oracle's private key.
F. The signed transaction is broadcast to the blockchain network.
G. Blockchain network clients may validate the signature by using the signed message and the oracle's public key to ensure that the transaction was initiated by the oracle.
H. If the signature is valid, the network clients accept the transaction and in doing so, alter the state of the memory of the clients by updating the indicator value stored in memory.
I. The alterations to the memory of the client are written to a future block in the blockchain.
J. If the indicator value change causes one of the funds value allocation to reach 0, price updates are halted and trading of the long and short units may be halted.
K. The oracle computer node could be a virtual machine executed by a blockchain network.

### Offering Memorandum

A cryptographic “fingerprint,” or “hash,” of one or more offering memorandum (OM) or prospectus, a document describing the terms of the investment, may be cryptographically tied to the token. An offering may have one or more offering memorandum. The long fund/token and the short fund/token may have their own offering memorandum. The token may be an ERC-20 Token Smart Contract. In some embodiments a self-describing hash can be used. Before cryptographically tying the OM or prospectus to a token, the token may be checked to verify that the OM or prospectus is not already stored in the token, for example, by name or by document hash.

The document may be tied to the token by the hash of the document being made available as a data member of the token. This provides cryptographic proof as to the connection between the OM and the token, and therefore the connection between the underlying asset or fund being traded through the token.

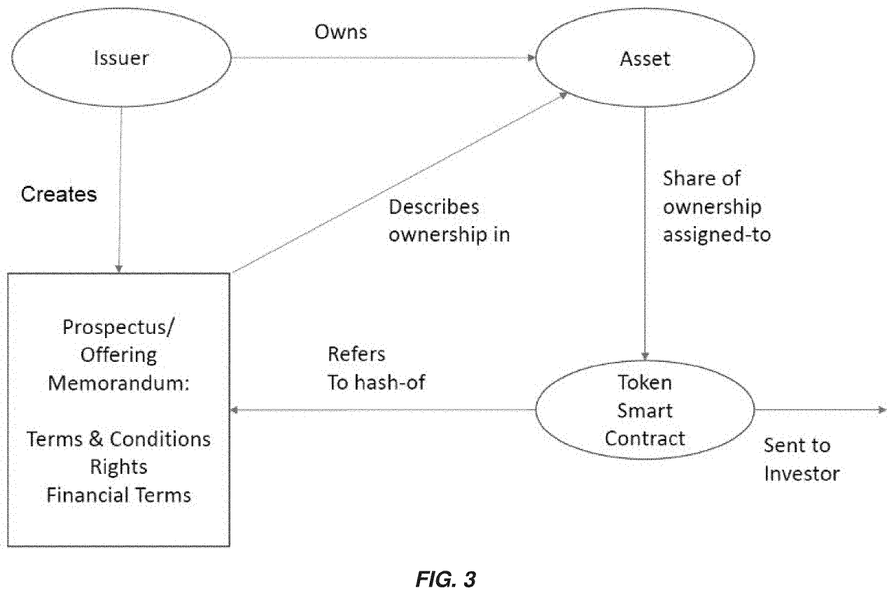

With reference to FIG. 3., the process may be carried out as follows:
A. The token may be deployed to the blockchain with a null or undefined value for the Offering Memorandum (OM) hash.
B. The cryptographic address identifying the contract (an entry point in to the contract governing the token) may be computed by a blockchain network client or node.
C. The cryptographic address may then be written into the OM or prospectus.
D. The cryptographic hash of the document, the OM or prospectus, is computed by the issuer. The hash may be calculated using an MD5 hash of the OM or prospectus. The hash algorithm results in a hash value that is preferably unique or substantially unique based on the document and can be repeatedly determined to confirm that a document is the same document for which the hash was originally calculated.
E. The issuer creates a transaction which will be used to update the OM or prospectus hash data field stored on the smart contract. This transaction will therefore update the memory of the blockchain nodes on the network. This transaction includes the cryptographic hash of the OM or prospectus to be stored in the smart contract.
F. The issuer signs said transaction with the issuer's private key.
G. The signed transaction is broadcast to the blockchain network.
H. Blockchain network client nodes validate the signature by using the signed message and the issuer's public key to ensure that the transaction was initiated by the issuer.
I. If the signature is valid, the nodes accept the transaction, which will alter the state of the memory of the clients, by updating the cryptographic hash date field of the smart contract with the hash of the OM or prospectus as stored in the memory of said blockchain client.
J. The alteration to the memory of said clients are written to a future block in the blockchain.
K. The issuer may upload the OM or prospectus to a content-addressable storage network, for example, a distributed file system, such as the InterPlanetary File System (IPFS) and addressable using the cryptographic hash of the OM or prospectus stored in the smart contract.
L. The storage network may utilize the same cryptographic hash function as was used earlier to address the document so that the document can be located using the hash.
M. Alternatively, the smart contract can reject the transaction if the hash stored in memory has previously been set (i.e., is not null or undefined). This prevents the hash of the prospectus from ever being changed after the initial setting.
N. Alternatively, the CUSIP number (Committee on Uniform Security Identification Procedures), ISIN number (International Securities Identification Number), or url to the OM in one of said depositories can be provided in the place of said OM hash, such that the security or offering memorandum can be located.

If more than one document is required to describe the offering, then each may have a process analogous to the above to link the document to the token. Each document may have its own storage location both in the smart contract and on an accessible storage position, such as IPFS. Smart contract storage locations can be individually referenced or in a data structure such as array. In this way, an investor, auditor, or other interested party can confirm the operating memorandum or other supporting document that was associated with the token.

ps Whitelist

The token or contract associated with the token may have a list of investors or investor identification information, such as account numbers or blockchain addresses that are permitted to hold token balances. The list may include the blockchain (e.g., Ethereum) addresses of the investors. The token balances could be prevented from being transferred to addresses not appearing in said list. Alternatively, token balances could be worthless and unredeemable if the address holding the balance is not on the list. The use and rules on the whitelist could be specified in the offering memorandum.

The whitelist may list investors that have passed Know Your Customer/Anti-Money Laundering (KYC/AML) validation by the issuer, and/or whom have satisfied further or alternative criteria of the fund to invest in the fund.

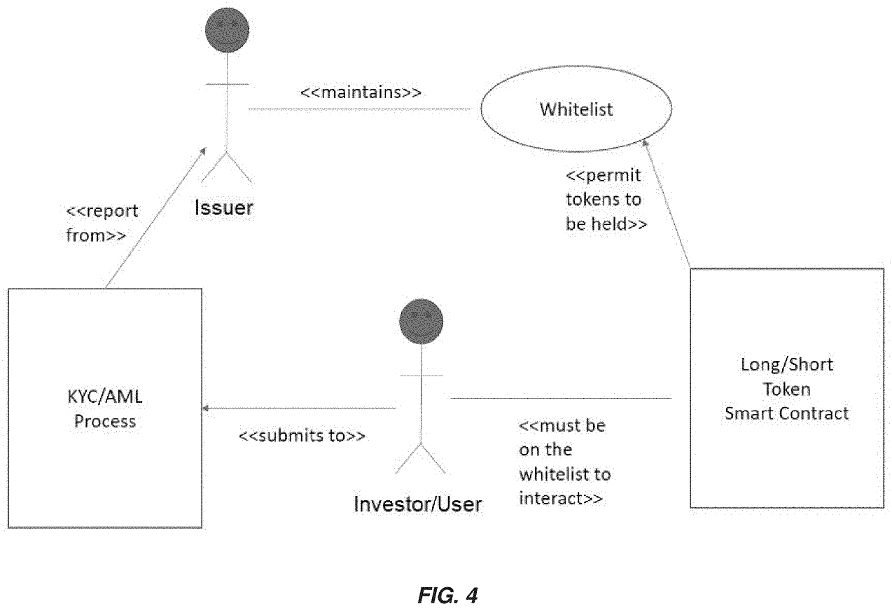

With reference to FIG. 4, the following steps may be used to perform a transfer of units of a fund from one investor to another:
A. A first investor (unit holder) creates a transaction to transfer a number of units of a fund to a second investor, as identified by the second investor's blockchain account address.
B. The first investor signs said transaction with the first investor's private key and includes in the transaction the number of units to send as well as the receiver's (second investor's) blockchain account address.
C. Said signed transaction is broadcast to the blockchain network.
D. Blockchain network clients validate the signature by using the signed message and the public key of the first investor to ensure that the transaction was initiated by the first investor.
E. If the signature is valid, the network clients accept the transaction, which may alter the state of the memory of the clients (as outlined in the following step), and the resulting changes are written to a future block in the blockchain.
F. The blockchain clients further:
   1. Compute whether the first investor has sufficient units to send to the second investor. If the investor's balance is less than the amount proposed to be transferred, the transfer does not proceed, and any steps already taken are rolled back.
   2. Compute the hash of the second investor's blockchain address and use it as a lookup into the whitelist data structure, which may be included in tokens associated with the units of the fund on the blockchain. Said data structure contains a flag which indicates whether or not the address is on the whitelist. An embodiment of said data structure may be a merkle, or patricia tree, or other “hash-map” data structures.
   3. If the lookup in said data structure indicates that the second investor's blockchain address is on the whitelist (i.e., permitted), and the first investor has sufficient units to send to the second investor, subtract the specified number of units from the first investor's balance and add the same number of units to the second investor's balance.

In some embodiments, a whitelist may be maintained and people not on the whitelist are prevented from doing token conversions (e.g., to/from stablecoin).

The issuer administers the list, such as by performing regulatory requirements on prospective investors. The requirements may include know your client (KYC) and/or anti-money laundering (AML) verification on all holders of said units. The “whitelist” feature reduces the risk of theft or other fraud, as all unit owners would be on the whitelist and therefore known to the issuer.

Regulatory requirements, such as for KYC/AML, may include prospective investors submitting personal information and verification documents, the specifics of which may vary by region. Common personal information verification documents could include, passport, driver's license, and “selfie” photograph. A whitelist oracle may be used. Such an account is controlled by the fund custodian/issuer, and it signs transactions which, once accepted by the blockchain, add or remove addresses from the whitelist. In some embodiments, there could be roles or multiple individuals who can administer the whitelist. The whitelist may include metadata that may include a (hashed) record or receipt of the KYC/AML process performed.

The whitelist oracle transactions may include the following:
A. Issuer requests personal information and supporting documentation from a potential investor.
B. Investor supplies said information as well as the investor's blockchain account address.
C. Issuer uses centralized or decentralized tools to verify the investor's identity and that the investor is not on any blacklists preventing sale of units to this investor.
D. If the investor's documentation pass confirmation and the investor is not on a blacklist, the issuer creates a transaction that would add the investor's blockchain account address to the whitelist.
E. The issuer signs said transaction with the issuer's private key.
F. Said signed transaction is broadcast to the blockchain network.
G. Blockchain network clients validate the signature by using the signed message and the public key of the issuer to ensure that the transaction was initiated by the issuer.
H. If the signature is valid, accept the transaction, which alters the state of the memory of said clients, and the resulting changes are written to a future block in the blockchain.

### Auditing

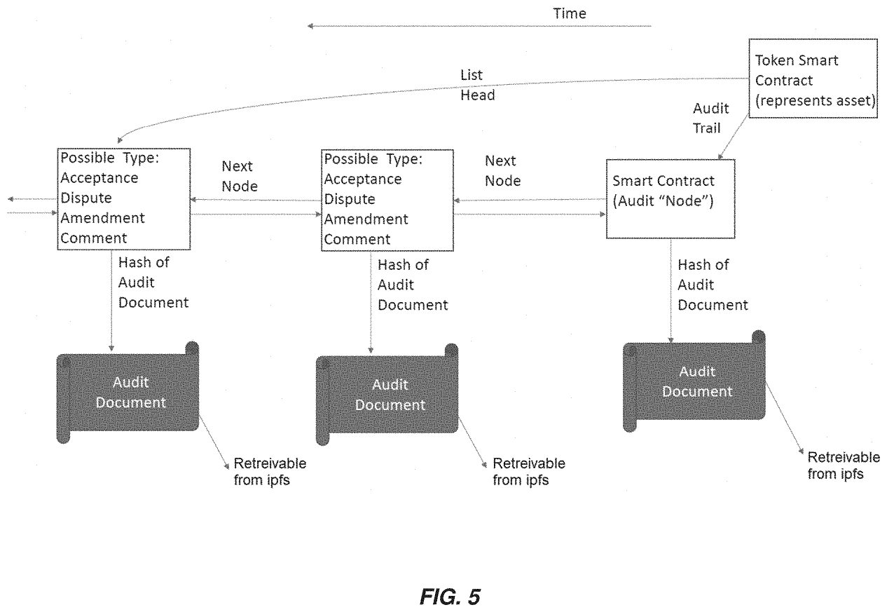

With reference to FIG. 5, an auditing process document may be cryptographically tied to the tokens. The auditing process may provide assurance that the capital allocated to said funds are always accounted for and available for redemption. A cryptographic hash is stored as a data member of the smart contract and refers to documentation of said auditing process. In some embodiments, a self-describing hash could be used. IPFS may be used.

The issuer may be able to change the auditor, such as by updating the auditing process document. In some embodiments, a list of authorized auditors from which the issuer may choose may be maintained.

The steps for the auditing process may include:
A. The auditor produces a report and supporting documentation relating to the financial transparency of the funds.
B. The auditor computes the cryptographic hash of the report and supporting documentation.
C. The auditor creates a transaction to update the audit trail which includes said cryptographic hash.
D. The auditor signs the transaction with the auditor's private key and includes in the transaction the cryptographic hash as well as indicating the type of update to the audit trail.
E. The signed transaction is broadcast to the blockchain network.
F. Blockchain network clients validate the signature by using the signed message and the public key of the auditor to ensure that the transaction was initiated by the auditor. The public key of the auditor may be included in the smart contract by the issuer or obtained from public sources at the time of validation.
G. If the signature is valid, the clients accept the transaction, which may alter the state of the memory of said clients (as outlined in the following step), and the resulting changes are written to a future block in the blockchain.
H. The blockchain clients further:
   1. Create a new data structure node which encodes the type of update to the audit trail as one of several status codes, and also includes said hash of the audit report and supporting documentation.
   2. At the outset when there is not yet any auditing documentation, a first “node” in a chain (or list) of auditing events with corresponding documentation attached to each node is created. In the case that there are existing nodes in the history of the audit trail the new node is appended to the end of the list.
   3. The smart contract may maintain a reference to one or both of the head and tail of the list of auditing events for convenient access of parties that wish to examine the audit trail.
   4. Any parties wishing to examine the audit trail can confirm that the auditing report and supporting documentation correspond to the hashed values in the audit trial. The auditing report and supporting documentation may be retrievable from an accessible location, such as the auditor or issuer website or a decentralized storage system, such as a content-addressable storage solutions using the hash stored on the audit trail.

### Pause Trading

An issuer can freeze or pause trading of units in the investment funds. Freezing of trading may be triggered automatically if the price of the underlying asset according to the indicator oracle causes the capital allocation to one of the funds to reach 0. If the capital allocation to one of the funds to reaches 0 the value of the units in the other fund may be redeemed or rolled over into a new capitalized vehicle or instantiation of the funds. If the capital allocation to one of the funds to reaches 0 the issuer may set a flag in the tokens of the funds to indicate that trading has ended, for example, by setting an “Ended” flag to “true.” Alternatively, smart contracts associated with the funds may automatically set the “Ended” flag to “true” responsive to capital allocation to one of the funds to reaching 0.

Trading of units in the funds may be paused without causing trading to be forever ended, for example, by the issuer set a flag in the tokens of the funds, for example, a “Paused” flag to “true.” Smart contracts associated with the funds may emit an indication or event when trading in units of the funds has been paused by the issuer. Smart contracts associated with the funds may automatically set the “Paused” flag to “true” responsive to receiving an indication that trading of the units is not proceeding as intended, for example, if there is a large degree of disagreement from different sources regarding the value of the indicator being tracked by the investment funds, a large number of transactions being denied, or for some other reason indicative of improper operation of the investment funds or emergency event.

The issuer can unpause or unfreeze trading only in the case that the value of both the long and short funds and their associated units is not 0.

The smart contract or plurality of smart contracts that implement the short and long unit positions, may have a data member, such as a paused flag, which in memory stores a flag that is checked whenever a non-issuer signed transaction is processed by the smart contract. An example would be a token holder requesting a transfer of tokens to another address.

The steps relating to the freeze and paused flags may include:
A. Trading frozen due to price of the units of one fund reaching 0-Following a successful price update, if the smart contract computes the value of both funds and if either value is 0, then said Ended flag is set to “true.”
B. Trading paused due to emergency event
   1. If the issuer deems that some exceptional event such as security breach, blockchain fork, or other unforeseen systemic effect has occurred, issuer may craft a transaction to update the paused flag.
   2. The issuer signs the transaction with the issuer's private key.
   3. The signed transaction is broadcast to the blockchain network.
   4. Blockchain network clients validate said signature by using the signed message and the public key of the issuer to verify that the transaction was initiated by the issuer.
   5. If the signature is valid, said blockchain clients accept the transaction, which alters the state of the memory of said clients to indicate that said paused flag is “true,” and the resulting changes are written to a future block in the blockchain.
C. Checking whether the contract is paused before executing a unit holder-initiated transfer of units: If the smart contract receives a transaction that would cause ownership of units to be transferred from one owner's address to another's, the smart contract may perform the following checks (in any order)
   1. Verifies that the transaction is signed by the account from which units are being transferred.
   2. That the balances of units allocated to said address is equal to or exceeds that being sent.
   3. Additionally, that the unit smart contract does not have the paused flag set to “true.”
D. Trading un-pause
   1. If the issuer deems that trading and transfer of tokens can resume following some exceptional event such as security breach, blockchain fork, or other unforeseen systemic effect has occurred, issuer will craft a transaction to update said paused flag.
   2. The issuer signs said transaction with the issuer's private key.
   3. The signed transaction is broadcast to the blockchain network.
   4. Blockchain network clients validate the signature by using the signed message and the public key of the issuer to verify that the transaction was initiated by the issuer.
   5. If the signature is valid, said blockchain clients perform a check to ensure that the allocated value of either of the funds (long and short) has not reached 0, accept the transaction, which alters the state of the memory of said clients to indicate that said paused flag is “false,” and the resulting changes are written to a future block in the blockchain.

If the trading of the fund becomes frozen due to the short or long position reaching a NAV of 0, funds may be raised only for the side that has reached a NAV of 0. The original funds raised can be kept intact, less any redemptions and expenses, and re-used once the side reaching a NAV of 0 is re-capitalized. The smart token may issue, or “mint,” new tokens for each unit purchased by investors re-capitalizing the side reaching a NAV of 0. Recapitalization creates both long and short fund units in equal amounts.

In some implementations, as part of a recapitalization process, forced redemption of units in the fund that have not dropped to zero happens first. The number of outstanding long fund units and short fund units is brought to 0 before recapitalization.

Trading may be resumed once the fund has reached 1:1 capitalization. Once resumed, the fund allocation between the funds can resume based on the movement of the indicator value. This can occur through two mechanisms: re-capitalization of said side reaching a NAV of 0; and optionally redemption of funds in the opposite side (the side reaching 100% NAV). The recapitalized fund may have a new NAV and new strike price.

During a recapitalization, additional tokens may be issued to investors in addition those rebalancing the funds. The issuer may leave funding (offering) open, such as may be specified in the Term Sheet/ Offering or Memorandum/Prospectus. The funding may be left open until the 1:1 capitalization is reached, such that NAV_short/NAV_long=1.

However, if there are investors on the waiting list for the overcapitalized side, the issuer may leave open the offering period until demand is satisfied and some or all of the investors on the waitlist are satisfied. This includes the possibility of leaving the offering open at all times, even once fund allocation based on the external index has begun.

The distribution or minting of tokens may involve the following steps:
A. One or more investors may purchase a number of units (long or short) from the issuer. This may include providing payment, meeting any conditions, such as KYC/AML checks, and providing a blockchain address to which tokens will be assigned.
B. The issuer may verify that sufficient payment is received from each of the investors for the number of units they request, along with meeting the preconditions and that the address is valid. Records of this information may be maintained by the issuer, such as for redemptions.
C. The issuer may create a transaction that when executed by the computer nodes in the blockchain network will change the record of the amount of units associated with each of the investors in tokens held at the blockchain addresses of the investors.
D. The issuer may sign the transaction with the issuer's private key.
E. The signed transaction may be broadcast to the blockchain network.
F. Blockchain network clients may then validate the signature by using the signed message and the public key of the issuer to ensure that the transaction was initiated by the Issuer.
G. If the signature is valid, accept the transaction, which may alter the state of the memory of said blockchain computer nodes to increase the number of tokens held by the blockchain address by the number of units. The resulting changes will be written to a future block in the blockchain.

### Conversions and Exchanges

The following conversions between units of value are possible:

Long+Short units to Stablecoin [longShortsToStablecoin( ) in exchange] A.

An investor who owns one or more units in the short fund and one or more units in the long fund may exchange pairs of long and short fund units for stablecoins. One short fund unit and one long fund unit may be exchanged for one stablecoin. The value of the stablecoin will be the sum of the values of the short fund unit long fund unit. An investor may only exchange long and short fund units for stablecoins when the investment funds are not ended, for example, when trading in the investment fund units is not frozen. An investor may only exchange long and short fund units for stablecoins when the investor requesting the exchange is in a whitelist associated with the investment fund. Further, an investor may only exchange long and short fund units for stablecoins when the investor has enough long and short fund units to pay for the amount of stablecoins requested. The investor may only exchange whole numbers of long and short fund units for whole numbers of stablecoins.

Stablecoin to Long+Short tokens [stablecoinToLongShort( )in exchange] B.

An investor owning one or more stablecoins may exchange stablecoins for equal numbers of units in the long fund and units in the short fund. The investor may only exchange whole numbers of stable coins for whole numbers of units in the long fund and units in the short fund. If an investor owns fraction of a stablecoin, that fraction may not be exchanged for fractions of units in the long and short funds. An investor may end up with a fractional unit of a stablecoin by purchase or sale of a fraction of a stablecoin on the open market.

An investor may only exchange stablecoins for long and short fund units when the investment funds are not ended, for example, when trading in the investment fund units is not frozen. In some embodiments, an investor may only exchange stablecoins for long and short fund units when the investor requesting the exchange is in a whitelist associated with the investment fund. Further, an investor may only exchange stablecoins for long and short fund units for stablecoins when the investor has enough stablecoins to pay for the number of long and short fund units requested. The investor must have enough stablecoin to create at least one long fund unit/short fund unit pair.

Stablecoin to Issuer credit [stablecoinToCredit( ) in exchange] C.

An investor who owns one or more stablecoins may exchange stablecoins for Issuer credits. The investor may exchange one stablecoin for one Issuer credit, i.e., a 1:1 conversion. Such an exchange will decrease the total NAV of the fund. An investor may only exchange stablecoins for Issuer credits when the investor requesting the exchange is in a whitelist associated with the investment fund. Further, an investor may only exchange stablecoins for Issuer credits when the investor has enough stablecoins to pay for the number of Issuer credits requested. The investor may only exchange whole numbers of stablecoins for whole number of Issuer credits.

Administrator force redemption (Variant on Long+Short tokens to Stablecoin) [stablecoinToCredit( ) in exchange] D.

Under the condition that the value of one of the long or short fund and its associated units drops to zero, further trade in the units of the funds may be frozen (ended) and the fund administrator may force an exchange of investors' long fund units and short fund units for stablecoins. In such an instance the investors need not have any units of the fund that dropped to zero in value for the exchange to proceed because the value of units in the fund whose value dropped to zero would also have dropped to zero. A forced exchange of the investors' fund units for stablecoins may only be instantiated by the administrator of the investment fund. The forced exchange of the investors' fund units for stablecoins may only be instantiated when the trading in the funds is frozen and ended. A forced exchange of an investors fund units for stablecoins may only proceed when the investor has a non-zero balance of either units on the long fund or units in the short fund, whichever has remaining value at the end of trading of units in the funds.

Fiat to Stablecoin [fiatToStablecoin( )in exchange] E.

During operation of the investment fund, the fund administrator may offer additional stablecoins for sale to investors. The value of each stablecoin will be the sum of the value of one unit in the long fund and one unit in the short fund. The sale of additional stablecoins will increase the NAV of the investment fund.

Issuer Credit to Fiat [creditToFiat( ) in ledger] F.

An investor may exit the investment fund by exchanging Issuer credits for fiat currency. An investor may request an exchange of his Issuer credits for fiat currency, but the administrator must initiate the transaction. In some embodiments, the investor must be in a whitelist associated with the investment fund for the request for exchange of Issuer credits to fiat currency to be approved. In some embodiments, the investor must provide a hash. The hash may be any hash of an identity support document. This would be matched against a document provided during a KYC/AML process. The hash may be a hash of a receipt of a previous KYC/AML check for exchange of Issuer credits to fiat currency to be approved. The investor must have sufficient Issuer credits to be redeemed for the amount of fiat currency requested.

Credit To Stablecoin [creditToStablecoin( ) in exchange, sendCreditToOtherExchange( ) in Issuer Ledger] G.

A scenario may occur that there are multiple funds being operated by the Issuer concurrently, for example a first fund tracking Bitcoin (BTC) and a second fund tracking the value of shares in Apple (AAPL). In this case, a smart contract called the Issuer Ledger is used to track balances and transfer value between stablecoins associated with the first fund and stablecoins associated with the second funds in a transparent, explicit, and auditable manner A process for an investor transitioning their investment from a first to a second fund may include the following:
1. The investor sends a transaction to the Issuer Ledger requesting to convert a number of stablecoins in the first fund to Issuer Credits.
2. If the investor has a sufficient number of stablecoins in the first fund, then the

Issuer Ledger performs the conversion by deducting said number from the investor's balance of stablecoins in the first fund and increasing the corresponding number of Issuer Credits assigned to the investor based on an exchange rate.
3. The investor sends a transaction to the Issuer Ledger requesting to convert a number of Issuer Credits to stablecoins in the second fund. If the investor has a sufficient number of Issuer Credits, then the Issuer Ledger performs the conversion by deducting said number from the investor's balance of Issuer Credits and increasing the corresponding number of stablecoins in the second fund assigned to the investor based on an exchange rate.
4. In some embodiments, the investor must be on in a whitelist associated with the investment fund for the request for exchange of Issuer credits for the target fund's stablecoin to be approved.

### Redemption

Investors may request that their investment in the funds be redeemed. Redemption of the investment of an investor in the fund results in the time of the redemption and the current price of the redeemed long and/or short fund units to be logged to the blockchain.

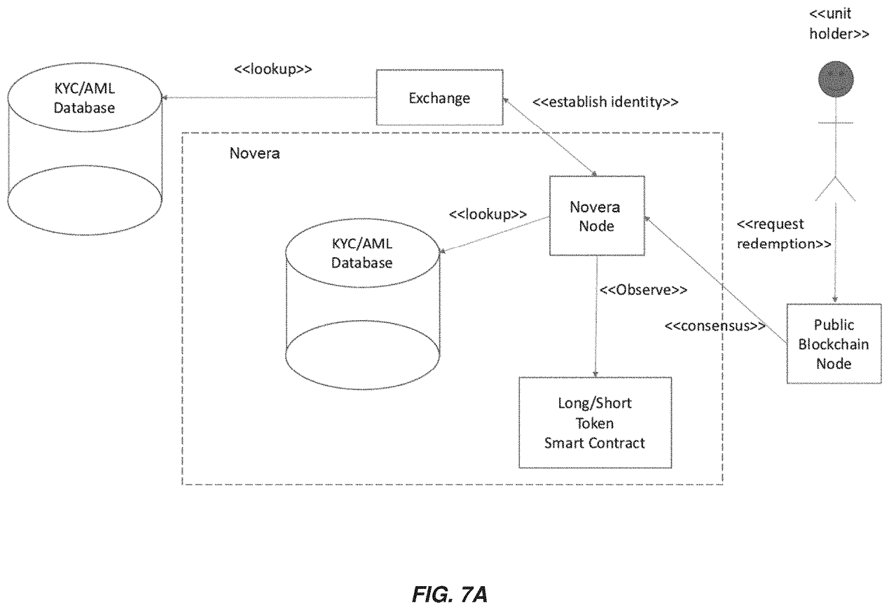

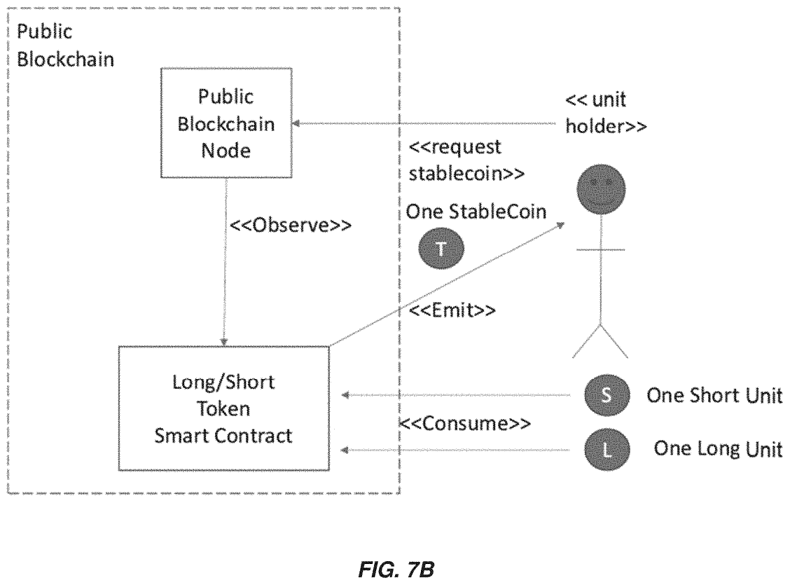

With reference to FIGS. 7A and 7B, the steps for redemption may include:
A. A fund unit holder wishing to redeem fund units will create a transaction to redeem a specified number of fund units.
B. Optionally, the fund unit holder may specify a minimum price for redemption of the fund units.
C. The fund unit holder signs the transaction with the fund unit holder's private key.
D. The signed transaction is broadcast to the blockchain network.
E. Blockchain network clients validate the signature by using said message, said message signature, and the public key of said fund unit holder to verify that the transaction was initiated by said fund unit holder.
F. If the signature is valid, the blockchain clients additionally perform a calculation to ensure that the number of fund units assigned to said fund unit holder is equal to or exceeds the amount requested to be redeemed. If sufficient (per said calculation), the number of fund units redeemed is subtracted from the unit holder's balance.
   1. In the case that the minimum price was provided in the message sent by the fund unit holder the blockchain client nodes perform a calculation to ensure that the current price of the fund unit in the smart contract (redemption price) exceeds the minimum provided by the investor.
G. The price at which the fund unit holder redeemed the fund units is stored on the blockchain immutable ledger (time plus current index price in the smart contract).
H. A blockchain node, controlled by the issuer observes transactions and events emitted from the smart contract. When said blockchain node observes a redemption event, it initiates a check against the issuer's database of approved investors, such as the whitelist, which maps addresses to the investor identification information.
I. Said fund unit holder that has redeemed their fund units can be identified by their information in the issuer's database, and their corresponding address in said database.
   1. In embodiments in which a whitelist is not used, the fund unit holder can identify themselves by signing a message (using their private key) containing their supporting documentation (including document number).
   2. The entity involved in the final redemption uses the fund unit holder's public key to ensure that the signed supporting documentation matches that presented in person by said assumed fund unit holder.
   3. Alternatively,
      i. The hash of the supporting document can be computed by the fund unit holder.
      ii. Instead of signing the supporting documentation, the fund unit holder signs the hash of the supporting documentation.
      iii. The entity involved in the final redemption performs the same hashing computation and compares whether the hash is the same as the hash supplied by the fund unit holder.
      iv. If successful, the fund unit holder is paid out in fiat as outlined below.

The amount paid out as part of a redemption may be calculated as
(7) Amount paid to a fund unit holder Redemption=(number of fund units being redeemed/total number of fund units)*(NAV of held position)−redemption fee

The redemption may be paid out in fiat currency or the issuer may partner with one or more cryptocurrency exchanges and maintain an exchange account on one or more partner exchanges so that cryptocurrency may be distributed to the investor.

To arrange a payout:
A. The issuer may transfer funds from the fund account into the issuer's exchange account with a cryptocurrency exchange.
B. The exchange may establish the identity of the fund unit redeeming individual by matching customer records with those of the issuer. This may be done using single sign on (SSO) technology to create a corresponding relationship associating the fund unit redeeming individual's record within the issuer's database to the identity in the exchange's identity database.

The issuer may issue a request to the exchange to pay out a fund unit holder who has an account on said exchange. Any conventional payment process may be performed, such as using the Tether (USDT) cryptocurrency.

Alternatively, the smart contract can be used directly to provide an immediate redemption.
A. In addition to the price of the tracked asset, the spot price of a cryptocurrency, such as Ethereum (ETH) is also updated on the smart contract via the aforementioned indicator index mechanism.
B. The fund unit holder wishing to redeem fund units will create a transaction to redeem the indicated number of fund units. Optionally, the fund unit holder specifies a minimum acceptable price for redemption of the fund units.
C. The fund unit holder signs said transaction with the fund unit holder's private key.
D. Said signed transaction is broadcast to the blockchain network.
E. Blockchain network clients validate said signature by using said message, said message signature, and the public key of said fund unit holder to verify that the transaction was initiated by said fund unit holder.
F. If the signature is valid, said blockchain clients additionally perform a calculation to ensure that the number of fund units assigned to said fund unit holder is equal to or exceeds the amount requested to be redeemed. If sufficient (per said calculation), the number of fund units redeemed is subtracted from the fund unit holder's balance. In instances that the minimum price was provided in the message sent by the fund unit holder the blockchain client nodes perform a calculation to ensure that the current price of the fund unit in the smart contract (redemption price) exceeds the minimum price.
G. The smart contract performs a calculation of the cryptocurrency to be paid on upon redemption using the price of cryptocurrency and the fund unit being redeemed.
H. The said amount of cryptocurrency is sent to the fund unit holder.
   i. Alternatively, the said amount of cryptocurrency can be set aside for later withdrawal.
   ii. Another alternative is to put the fund unit holder in line for a stream of cryptocurrency that goes into the contract, until a “bucket” is full.

With reference to FIG. 7B, redemption may require or allow the fund unit holder to redeem long and short fund units in a 1:1 ratio in order to redeem. The redemption event is as above, however a check is made that the fund unit holder has a sufficient number of each of the long and short fund units. The redemption transaction emits a combination of long and short fund units that do not fluctuate in value—i.e., they are stable to the token holder's address. A combination of a long and short fund units may be encapsulated as a single stablecoin. Stablecoins may be traded or redeemed as their own entity. As discussed above, a stablecoin may have restrictions on when it can be split into a long and short fund units. Each unit of a matched long/short fund unit represents one redeemed long and one redeemed short position. The matched long/short fund unit, can be in turn redeemed per the same processes outlined above, with the exception that the redemption price does not change over time.

In another embodiment, redemption of long and/or short fund units may be performed by first exchanging the long and/or short fund units to stablecoins, exchanging the stablecoins for Issuer credits, and then exchanging the Issuer credits for fiat currency:

Long+Short→Stablecoin→Issuer Credit→Fiat (8)

There are two ways in ways in which an investor may convert their long and/or short fund units to stablecoin(s). In one method, an investor holding long (or short) fund units can find the other side in the market and purchase a number of short (or long) fund units so that they have an equal number of long and short fund units and 1:1 long and short pairs in their account to convert to stablecoins when the fund is still active. In another method when the long and short funds are frozen and end, the fund administrator can force redemption of a user's long or short position into stablecoins, without requiring that the user having long and short fund units in a 1:1 ratio.

In some embodiments a fund investor must be on a whitelist associated with the investment fund to redeem fund units.

Redemption of fund units for an investor who has X long fund units and Y short fund units in their account may proceed as follows:
A. If the fund has not ended, the user converts their X long fund units and Y short fund units into Z stablecoins. Z equals the min(X,Y). This transaction takes place on the blockchain.
B. If the fund has ended, the fund administrator converts the user's X long fund units and Y short fund units into X or Y stablecoins, depending on which of the long fund units or short fund units has value at the end of the fund. This transaction may be initiated by the fund administrator or initiated automatically by a smart contract associated with the fund units and may take place on the blockchain.
C. Convert the stablecoins to Issuer credits at a 1:1 ratio. This transaction may be requested by the user and may take place on the blockchain.
D. The user sends a request to the fund administrator that they want to redeem Z Issuer credits to fiat currency. This transaction may take place off chain. This request may be performed off-chain, because it has the potential for abuse/double spend, since the processing to go from credit to fiat is a purely centralized/offchain business process. In other embodiments, this request and transaction may be performed on the blockchain.
E. The administrator or issuer freezes or transfers the user's Issuer credits.
F. The fund administrator takes Z dollars from cash reserves and deposits it in the user's bank account. Alternatively, the Issuer credits may be redeemed for cryptocurrency, for example, Bitcoin and the cryptocurrency transferred to the cryptocurrency wallet of the user. The fund administrator creates a document with details of this transaction and creates IPFS hash of it.
G. The fund administrator finishes the process by calling a creditToFiat function, which removes Z amount of user's Issuer credits from the investment fund account of the user and takes in the IPFS receipt detailing the offchain bank transaction.

With reference to paragraph “D” above—the blockchain version may involve the following:
1. The fund investor wishing to redeem Issuer Credits will create a transaction to redeem the indicated number of fund units for equivalent fiat cash or cryptocurrency.
2. The investor signs said transaction with the investor's private key.
3. Said signed transaction is broadcast to the blockchain network.
4. Blockchain network clients validate said signature by using said message, said message signature, and the public key of said investor to verify that the transaction was initiated by said investor.
5. If the signature is valid, said blockchain clients additionally perform a calculation to ensure that the number of Issuer Credits assigned to said investor is equal to or exceeds the amount requested to be redeemed. If sufficient (per said calculation), the number of Issuer Credits redeemed is subtracted from the investor's balance. Issuer Credits are put into a frozen state where the Issuer Ledger will reject future Investor signed transactions affecting the frozen Issuer Credits. In one embodiment the Issuer Credit adheres to the ERC20 protocol or similar transferable token; in this case the Issuer Credits are transferred to an address controlled by the Issuer. Said Issuer address or set of addresses can be published using the Issuer Ledger or another smart contract.
6. The said amount of fiat or cryptocurrency is transferred to the investor.
7. The said frozen Issuer Credits are deducted from their respective holder's address.
8. An event/notification is issued for observers to verify that the transaction was completed. The notification may include a receipt of the transaction. Additionally a record of a performed KYC/AML process may be included in the notification. Alternatively, said receipts could be hashed, and the hash emitted in the notification.

### Document Retrieval

The offering memorandum and auditing documentation may be retrievable from a content-addressable-storage system such as IPFS by their respective hashes as described above. The investor requesting an OM, Prospectus, or Auditing report may be done by:
A. Investor can query the smart contract for the hash of the document of interest. This does not involve a transaction sent to the blockchain, rather it is queried from the database of blocks maintained by a blockchain node.
B. The investor sends a request to the content-addressable storage network requesting the document corresponding to the hash of the OM or prospectus.
C. A content addressable storage node replies with a document matching said hash of the OM or prospectus.
D. Investor verifies that document content is correct by computing the result of applying the hashing function to said document and comparing to the published hash received earlier from the smart contract.
E. If the resulting said hash values match, then the investor can take the contents of the OM or prospectus returned by said content-addressable storage network as true. Otherwise the investor rejects the returned OM or prospectus.

Cryptographic Signatures

Whenever an oracle, user, or the security token issuer interact with the blockchain, it's assumed that all the transactions are cryptographically signed using a scheme with embodiments that include PKI, RSA or a similar scheme.

All transactions may be signed cryptographically with the private keys of all unit holders and various oracles.
A. Transaction originator signs the transaction with its private key.
B. Transaction originator broadcasts the transaction and the signature to the network of computers, the nodes or clients, comprising the blockchain network.
C. Clients validate the signature by using the signed message and the public key of the originator to ensure that the transaction was initiated by the holder of the private key associated with the role.
D. If the signature is valid, accept the transaction, which alters the state of the memory of said clients, and the resulting changes are written to a future block in the blockchain.

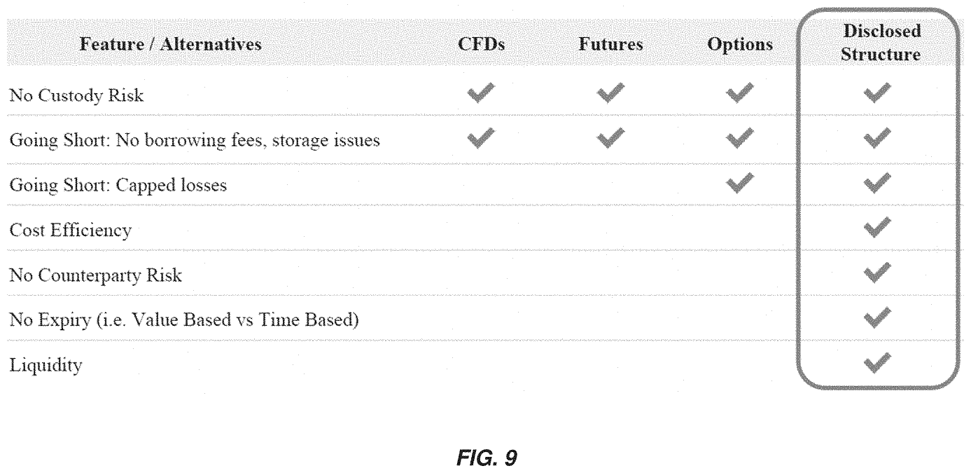

Advantages of aspects and embodiments of the method and system disclosed herein (Disclosed structure) for making investments in an investment vehicle tracking an indicator as compared to the use of contract for difference (CFD) vehicles, futures contracts, and options are illustrated in FIG. 9. As illustrated in FIG. 9, each of the CFD, Futures, Options, and the vehicles disclosed herein may carry no custody risk (the risk of a loss being incurred on securities in custody as a result of a custodian's insolvency, negligence, misuse of assets, fraud, poor administration or inadequate record-keeping), and may have no borrowing fees or storage issues for investing in short positions. Investments in options or the vehicle disclosed herein may have capped losses—an investor can only lose as much as they invest in the vehicles. In contrast, CFD and futures vehicles may have no cap for losses. Advantages of the vehicle disclosed herein over each of the CFD, futures, and options vehicles include cost efficiency, for example, due to the elimination of the majority of intermediaries by performing and recording transactions on a blockchain rather than through a brokerage. In contrast to the CFD, futures, and options vehicles the structure disclosed herein has no counterparty risk because units in the long fund and short fund are issued in a 1:1 ratio. Also in contrast to the CFD, futures, and options vehicles the structure disclosed herein has no expiration date for investments and high liquidity.

Unlike CFD, futures, and options, long and short fund units as disclosed herein have no counterparty risk. The funds to back the NAV of the fund units are always held in trust, until a liquidation event at which point the funds are paid to the unit holders. This ensures that the funds required for liquidity are always available. Also, there will be a robust secondary market for long and short fund units ensuring further liquidity. The potential market for fund unit investors will be much broader than the market for other derivatives like CFD, futures, and options, therefore ensuring more liquidity for the long and short fund units.

Various embodiments of the present disclosure having been thus described in detail by way of example, it will be apparent to those skilled in the art that variations and modifications may be made. The present application includes all such variations and modifications as fall within the scope of the appended claims.

What is claimed is:

1. A method for facilitating investments, the method comprising:
issuing ownership units in a long fund to investors, the ownership units in the long fund having values that increase based on an upward movement of an external indicator and that decrease based on a downward movement of the external indicator;
issuing ownership units in a short fund to investors, the ownership units in the short fund having values that decrease based on the upward movement of the external indicator and that increase in value based on the downward movement of the external indicator, each ownership unit in the long fund being issued for each ownership unit in the short fund being issued, the ownership units in the long fund increasing in value to by a same amount by which the ownership units in the short fund decrease in value for a given change in the external indicator; and
maintaining ownership and transactions records associated with the ownership units in the long and short funds in cryptographically secure tokens on a blockchain.

2. The method of claim 1, wherein the ownership units in the long and short funds may be traded only prior to the net asset value of one of the long fund or the short fund dropping to zero.

3. The method of claim 1, further comprising:
freezing trading of ownership units in the long and short funds responsive to the net asset value of one of the long fund or the short fund dropping to zero;
canceling all previously issued ownership units in the one of the long and short funds with the net asset value that dropped to zero;
issuing new ownership units in the one of the long and short funds with the net asset value that dropped to zero; and
resuming trading responsive to a number of newly issued ownership units in the in the one of the long and short funds with the net asset value that dropped to zero matching the number of outstanding ownership units in the other of the long and short funds.

4. The method of claim 1, further comprising forcing redemption of all ownership units in the one of the long and the short fund other than the one of the long and short funds with the net asset value that dropped to zero.

5. The method of claim 1, wherein trading of the ownership units in the long and short funds is implemented by one or more smart contracts recorded on the blockchain.

6. The method of claim 1, further comprising checking a whitelist responsive to a request by an investor to purchase, trade, or redeem ownership units in the long and short funds, and only permitting the investor to purchase, trade, or redeem the ownership units if the investor is included in the whitelist.

7. The method of claim 6, wherein the whitelist is recorded on the blockchain and is updateable by an administrator of the long and short funds.

8. The method of claim 1, wherein the external indicator is an exchange rate for a unit of a cryptocurrency.

9. The method of claim 1, wherein each of the ownership units in the long and short funds are assigned a same strike value of the external indicator against which changes in the external indicator are evaluated to determine value of the ownership units in the long and short funds.

10. The method of claim 1, wherein each of the ownership units in the long and short funds are issued at a same price.

11. The method of claim 1, wherein a maximum appreciation or depreciation in value of each of the ownership units in the long and short funds is capped at 100%.

12. The method of claim 1, wherein a percentage change in a value of the external indicator causes value of the ownership units in the long fund to change by the same percentage as the percentage change in the value of the external indicator and value of the ownership units in the short fund to change by a negative of the percentage change in the value of the external indicator.

13. The method of claim 1, wherein the ownership units in the long and short funds have values that are leveraged relative to changes in value of the external indicator wherein a percentage change in the value of the external indicator causes the value of the ownership units in the long fund to change by a non-unit multiple of the percentage change in the value of the external indicator and value of the ownership units in the short fund to change by a negative of the non-unit multiple of the percentage change in the value of the external indicator.

14. The method of claim 1, wherein redemption of ownership units in one of the long and the short fund comprises:
exchanging one ownership unit of the long fund and one unit of the short fund for one unit of a stable value stablecoin;
exchanging one stablecoin for one issuer credit; and
exchanging the issuer credit for fiat currency.

15. The method of claim 1, wherein issuing the ownership units in the long and the short fund comprises:
exchanging fiat currency for a stable value stablecoin; and
exchanging the stablecoin for one ownership unit in the long fund and one ownership unit in the short fund.

16. The method of claim 1, wherein the ownership units in the long and short funds are initially issued in equal amounts and at equal prices and wherein net asset values of the long and short funds are equal after initial issuance of the ownership units.

17. The method of claim 16, wherein trading in the ownership units in the long and short funds does not begin until after the initial issuance is completed.

18. The method of claim 16, further comprising entering prospective inventors on a waitlist for ownership units of a one of the long fund or the short fund that are more in demand until issuance of sufficient ownership units in the other of the long fund or the short fund to make a number of ownership units issued in each of the long fund and short fund equal.

19. The method of claim 1, further comprising recording a strike value of the ownership units in the long and short funds in the tokens on the blockchain.

20. The method of claim 1, further comprising cryptographically tying auditing records of the long and short funds to the tokens on the blockchain.

21. The method of claim 1, further comprising obtaining quotes of a value of the external indicator at set times from multiple sources and aggregating consensus regarding the value of the external indicator at each of the set times through a smart contract implemented on the blockchain.

22. The method of claim 1, further comprising cryptographically tying one or offering memorandum for the ownership units in the long and short funds to the tokens on the blockchain.
